(19) United States
(12) Patent Application Publication
(10) Pub. No.: US 2022/0134893 A1
(43) Pub. Date: May 5, 2022

(54) AUTONOMOUS WIRELESS ELECTRIC VEHICLE CHARGING SYSTEM

(71) Applicant: Motion Fusion Inc., Mountain View, CA (US)

(72) Inventors: Yang LIU, Mountain View, CA (US); Francesco BORRELLI, Kensington, CA (US)

(21) Appl. No.: 17/435,012

(22) PCT Filed: Feb. 28, 2020
(86) PCT No.: PCT/US20/20399

§ 371 Date: Aug. 30, 2021

Related U.S. Application Data
(60) Provisional application No. 62/811,755, filed on Feb. 28, 2019.

(51) Int. Cl. B60L 53/12; B60L 53/38; B60L 53/80; B60L 53/37; B60L 53/30

(52) U.S. Cl. CPC B60L 53/12; B60L 53/38; B60L 53/305; B60L 53/37; B60L 53/80

(57) ABSTRACT

A wireless autonomous electric vehicle charging system and method, the system including a charging station configured to receive electrical energy from an external source, a plurality of charging pads, each charging pad including a rechargeable battery and configured to be charged by the charging station, and to be placed under an EV for wireless charging of a battery of the EV, and an autonomous robot, the autonomous robot configured to retrieve one or more charging pads from the charging station and deliver the charging pad to an EV, wherein upon placement of the charging pad under the EV the charging pad wirelessly charges the battery of the EV.

### CROSS-REFERENCE TO RELATED APPLICATIONS

The instant application claims priority to U.S. Provisional Patent Application No. 62/811,755 entitled AUTONOMOUS WIRELESS ELECTRIC VEHICLE CHARGING SYSTEM filed Feb. 28, 2019, the entire contents of which is incorporated herein by reference.

### FIELD

This disclosure is directed to electronic vehicle (EV) charging systems and methods. More particularly, the disclosure is directed to an automated robotic wireless EV charging system.

### BACKGROUND

An electric vehicle (EV) charging station or charging point has become a common feature of many parking facilities, homes and other infrastructure. These EV charging stations supply electric energy for the recharging of electric vehicles, such as plug-in electric vehicles, including electric cars, neighborhood electric vehicles and plug-in hybrids. As electric vehicles and electric vehicle ownership is expanding, there is a growing need for widely distributed, accessible charging stations. However, various constraints have tended to limit the ability of charging infrastructures to maintain pace with the increase in demand. For example, the availability of charging stations in geographic area can be impacted by limitations on parking space numbers and locations, on power grid capacity, and on other factors. Further, the necessary retrofitting of existing architecture and infrastructure add significantly to the costs of establishing further charging stations. The instant disclosure is directed to addressing the shortcomings of existing systems and methods.

### SUMMARY

One aspect of the disclosure is directed to a wireless autonomous electric vehicle (EV charging system including: a charging station configured to receive electrical energy from an external source; a plurality of charging pads, each charging pad including a rechargeable battery and configured to be charged by the charging station, and to be placed under an EV for wireless charging of a battery of the EV; and an autonomous robot, the autonomous robot configured to retrieve one or more charging pads from the charging station and deliver the charging pad to an EV, where upon placement of the charging pad under the EV the charging pad wirelessly charges the battery of the EV. Other embodiments of this aspect include corresponding computer systems, apparatus, and computer programs recorded on one or more computer storage devices, each configured to perform the actions of the methods and systems described herein.

Implementations of this aspect of the disclosure may include one or more of the following features. The wireless autonomous EV charging system further including a server, the server configured to receive a request for charging and to transmit instructions to charging station, charging pads, or autonomous robot in response to the request for charging. The wireless autonomous EV charging system where the instructions identify one or more of a type of EV, a charging algorithm, a location of the EV, a duration of charge, a desired charge level, or a route to the EV. The wireless autonomous EV charging system where each of the plurality of charging pads include a height adjustment mechanism configured to bring a charging coil of the charging pad in proximity to a charging pad of the EV. The wireless autonomous EV charging system where each of the plurality of charging pads includes a wireless charger configured to convert direct current (DC) electrical energy in the rechargeable battery to an alternating current (AC) to enable wireless transmission of electrical energy to the EV. The wireless autonomous EV charging system where the charging station includes one or more battery chargers configured to receive electrical energy from the external source and convert the electrical energy to a form suitable for storage in the rechargeable battery of the charging pad. The wireless autonomous EV charging system where the charging station is configured to support and charge a plurality of charging pads. The wireless autonomous EV charging system where one or more of charging station, charging pads, and autonomous robot include a central processing unit including a communications module, and configured to receive and transmit communications with the charging station, charging pads, autonomous robot, a server, or an EV. The wireless autonomous EV charging system where the autonomous robot includes at least one robotic arm configured to engage a charging pad and remove it from a charging station and place it on the autonomous robot. The wireless autonomous EV charging system where the at least one robotic arm is configured to engage a charging pad on the autonomous robot and place the charging pad under an EV. The wireless autonomous EV charging system where the at least one robotic arm is configured to engage a charging pad located on the ground and place the charging pad on the autonomous robot. The wireless autonomous EV charging system where the autonomous robot further includes at least one sensor. The wireless autonomous EV charging system where the at least one sensor is selected from the group including of ultrasonic sensors, cameras, light detection and ranging (LIDAR) sensors, and inertial monitoring units (IMU). The wireless autonomous EV charging system further including a server in communication with an application running on a mobile device, the application configured to enable a user to request charging services for an EV. The wireless autonomous EV charging system where the application requires input of one or more of a type of EV, a location of the EV, a charging algorithm, a location of the EV, a duration of charge, a desired charge level, a payment method, a level of urgency, or a priority request. The wireless autonomous EV charging system where the server communicates with one or more of the charging stations, charging pads, and autonomous robot to receive charging status of the EV. The wireless autonomous EV charging system where the server communicates a received charging status of the EV to the application running on the mobile device. The wireless autonomous EV charging system where upon termination of charging, the autonomous robot retrieves the charging pad. The wireless autonomous EV charging system where upon retrieval of the charging pad, if the charging pad is in need of charging the autonomous robot returns the charging pad to the charging station. The wireless autonomous EV charging system where upon retrieval of the charging pad, if the charging pad has sufficient charge to charge another EV, the charging pad is retained on the autonomous robot for further use. The wireless autonomous EV charging system where the charging pads employ a closed loop current method for precise placement of a charging coil of the charging pad in proximity of a charging coil of the EV to achieve high efficiency inductive charging. The wireless autonomous EV charging system including a three-dimensional (3D) map formed from drawings of a parking structure and sensed features from ultrasonic sensors, cameras, light detection and ranging (LIDAR) sensors, and inertial monitoring units (IMU). The wireless autonomous EV charging system where the autonomous robot employs an application combining a Hybrid A* path planner and an optimization-based collision avoidance (OBCA) algorithm to determine a path for placement of the charging pad under an EV.

Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE FIGURES

FIG. 1 is a schematic diagram of an autonomous wireless charging system in accordance with the instant disclosure;

FIG. 2 is a charging station of an autonomous wireless charging system in accordance with the instant disclosure;

FIGS. 3A and 3B depict aspects of a charging pad of an autonomous wireless charging system in accordance with the instant disclosure;

FIG. 3C depicts two forms of wireless charging using the charging pad of FIGS. 3A and 3B:

FIGS. 4A and 4B depict aspects of an autonomous robot of an autonomous wireless charging system in accordance with the instant disclosure;

FIG. 5 is a schematic diagram of a CPU in accordance with the instant disclosure;

FIG. 6 is a network diagram of an autonomous wireless charging system in accordance with the instant disclosure;

FIG. 7 is a schematic diagram depicting a mapping system and algorithm in accordance with the disclosure; and

FIG. 8 is a schematic diagram depicting a pathway generation system and algorithm in accordance with the disclosure.

### DETAILED DESCRIPTION

This disclosure is directed to an electric vehicle (EV) charging system and method of charging. Instead of fixed charging stations which are dedicated to a single location in a parking garage or parking lot, the instant disclosure is directed to systems and methods of enabling EV charging at any location in a parking facility. To enable this “charge where you are” approach the system of the disclosure utilizes a charging robot which brings a charging pad that includes battery to a parked EV. The charging robot places the charging pad battery proximate the undercarriage of the EV and enables wireless charging of the batteries in the EV mobile wherever the EV is located in the parking facility. When the operator of the EV returns to vehicle, they are free to simply drive off, stopping the charging. The charging robot may retrieve the charging pad either after the EV leaves, or at the end of a charging cycle. Further, if another vehicle parks over the charging pad, and either has not requested charging or is in fact a non-EV, the charging robot can also retrieve the charging pad and utilize the charging pad for another vehicle. Further, the parking space is not limited to EV's but can be used by any vehicle without unduly burdening EVs. These and other methods and systems are described in greater detail below.

In the coming years EVs will take on an even more dominant role in meeting the transportation needs of the population. This transition from gasoline based fueling to electrical charging has already shown that the gas station model, where vehicle ranges of 3-400 miles can be added to a vehicle with a simple 10-minute fill-up is both impractical and currently technically impossible to duplicate for EVs. Current battery technology though vastly improved from just a few years ago, still requires time to achieve a similar amount of range extending charging of an EV's batteries.

The current attempted solution to the failings of the gas station model is the ubiquitous 3-10 charging stations that may be found in a variety of public locations such as parking lots and parking garages. But these solutions also present challenges. First, the use of current charging stations result is dedicated EV only parking spaces, which remove a valuable resource from use by all drivers. Moreover, because the resource is so valuable, and because there is little stigma associated with it as opposed to improperly parking in a handicapped space, many drivers simply ignore the presence of the charging station and park in the space regardless of their need to actually charge, and there is often little to no enforcement of parking restrictions. Relatedly, many locations, recognizing the value of the parking spaces, and the infrastructure costs associated with installation of the charging stations are disinclined to have such charging stations installed on their facilities.

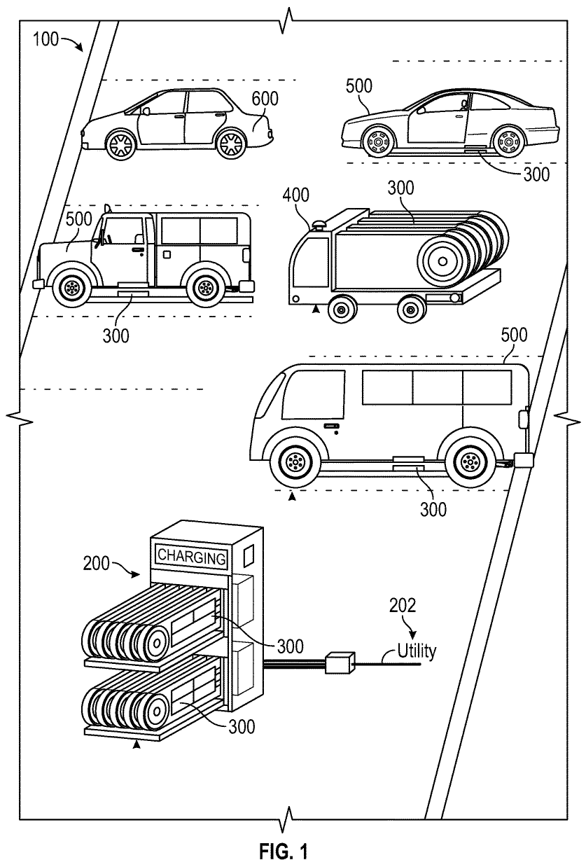

Regardless, the future of EV charging will still be largely deployed in public spaces. In accordance with the disclosure, a solution to the above-identified issues can be seen with reference to FIG. 1. In FIG. 1, an autonomous wireless EV charging system (AWECS) 100 is depicted. The AWECS 100 is composed of three primary components, each of which is described in greater detail below. A central charging station 200, is connected to a public utility as a source of electrical charging power, or alternatively to a dedicated source such as a solar array or other alternative energy platform configured to charge one or more charging pads 300. The charging pads 300, are stored in a charging station and may be charged via a wired connection. An autonomous robot 400, is configured to retrieve one or more charging pad 300 from the charging station 200 and place them under an EV 500. Once in place under the EV 500, the charging pad 300 wirelessly couples to the battery located within the EV and discharges its electrical energy to charge the battery of the EV. By placing the charging pads 300 under selected EVs 500 as requested, every parking space in the parking facility remains available for both EVs 500 and other vehicles 600. Further, by having a large number of charging pads 300 stored in the charging station, the times of charging the charging pads can be delayed outside of peak energy usage times, and delayed until evening hours or other times where energy costs and demands on the grid are reduced, thus increasing the efficiency of the existing utility grid. Still further, using transfer switch technology, solar or wind energy, which may be locally generated may be used as the primary source of charging energy during the daytime and other peak utility grid usage, to once again limit the impact of the AWECS 100 on the existing utility grid.

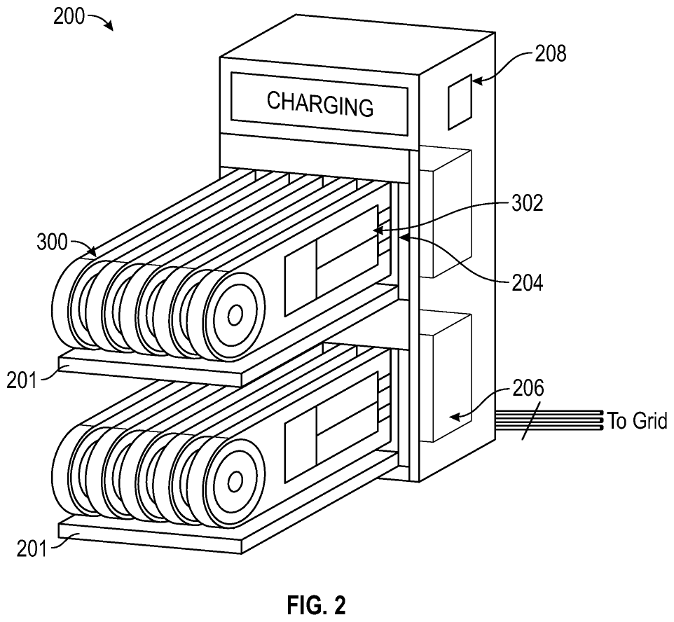

FIG. 2 depicts the charging station 200 of the disclosure. In one embodiment, the charging station 200 includes one or more racks 201. Supported on the racks 201 are a plurality of charging pads 300. Each charging pad 300 includes at least two leads 302, which mate with corresponding contacts 204 on the charging station 200. Each contact 204 is electrically connected to a battery charger 206. Though described herein as a physical connection between the battery charger 206 and the charging pads 300, the charging pads may also be wirelessly or inductively charged, without departing from the scope of the disclosure. The battery charger(s) 206 electrically connect to an energy source such as a mains connection to the utility grid or to an alternative energy source such as a dedicated solar array or a wind generator. As will be appreciated, both the charging station 200, and the charging pad 300 include a CPU 208, 314 including, a memory, one or more sets of instructions including software, firmware, applications, and an communications module for communication between the battery charger 206 and the batteries in the charging pad 300. These communications include data such as state of charge (SOC), depth of discharge, health of the cells of the batteries in the charging pad 300, temperature and other information relevant to the charging of batteries such as lithium-ion and other lithium chemistry batteries.

The communications module in the CPU 208 of the charging station 200 also enables communication to a server system, described in greater detail below. The communication to the server can allow for remote monitoring of the status of the charging pads 300 and the charging station 200, as well as other relevant communications for AWECS 100.

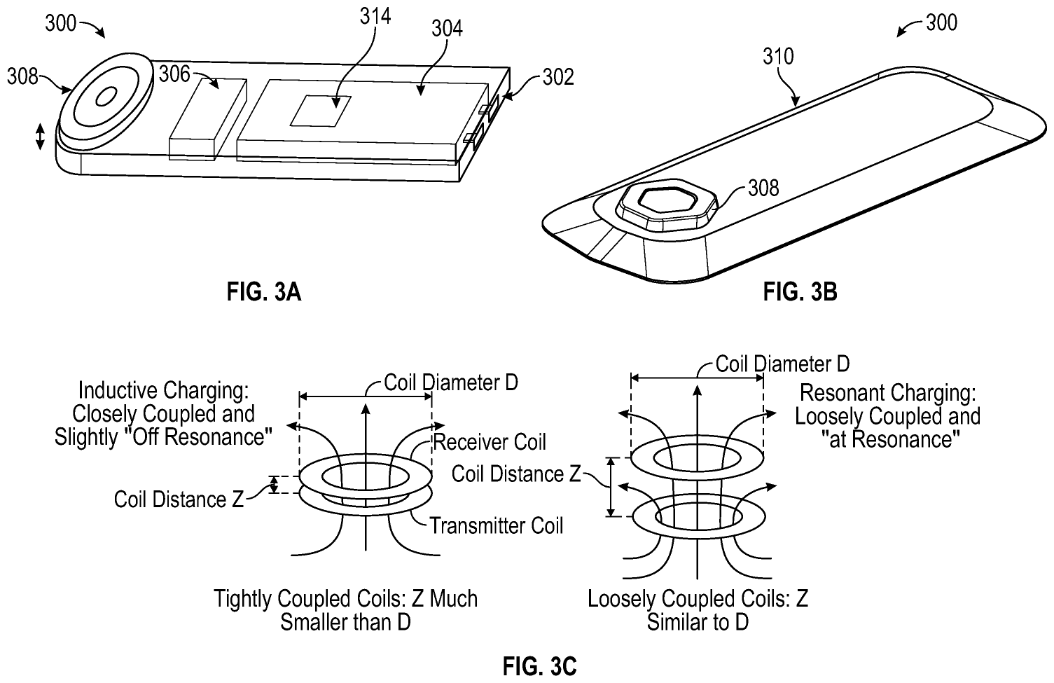

FIGS. 3A and 3B depict a charging pad 300 in accordance with the disclosure. The charging pad 300 includes leads 302 for connecting to the contacts 204 of the charging station 200. The leads 302 ae electrically connected to one or more batteries 304. The batteries 304 are charged by the charging station 200. Electrically connected to the batteries are a wireless charger 306. The wireless charger 306 converts the direct current (DX) electrical energy stored in the batteries 304 into an alternating current (AC). An AC signal output from the wireless charger 306 is received by an adjustable charging coil 308, and the wireless charging coil 308 generates an AC electrical field. A similar charging coil is present in the EV, and if withing the electrical field is inductively coupled to the charging coil 308 and wireless charger 306, causing the generation of an AC signal in the EV 500. This AC signal is received by a wireless charger, in the EV 500 which converts the AC signal to a DC signal used to charge the batteries of the EV.

As will be appreciated with any inductive charge circuit, close proximity of the charging coil 308 and the charging coil in the EV 500 is both desired and improves the efficiency of the transmission of the energy from the batteries 304 in the charging pad 300 and the EV 500. To achieve this proximity of the charging coil 308 and the corresponding charging coil on the EV 500, the charging coil 308 may have a height adjustment mechanism. This height adjustment mechanism may be mechanical, such as a rack and pinion gear drive connected to a drive motor which moves the charging coil vertically away from a top surface 310 of the charging pad 300. Alternatively, the height adjustment may be pneumatic, where compressed air is used to drive a piston connected to the adjustable charging coil to adjust its height and proximity to the charging coil of the EV 500. Movement of the height adjustment may be automatically enabled once proximity to the charging coil of the EV 500 is determined.

Alternatively, the initiation of the height adjustment mechanism may be controlled by the autonomous robot 400 via a wireless or wired communication with the charging pad 300. This communication may be undertaken following placement of the charging pad 300 under an EV 500. In some embodiments, the charging pad and the autonomous robot 400 remain in communication during and immediately after placement of the charging pad 300 and through the initiation of charging to ensure that the charging pad 300 is appropriately placed under the EV 500 for efficient charging of the EV batteries. Regardless of the mechanism, the eventual height the adjustable charging coil 308 is dependent on the height of the vehicle being charged.

Still further, the charging pad 300 may include one or more detection systems for ensuring proper alignment of the charging claim 308 and the charging coil of the EV 500. For example, RF signals may be employed by the charging pad to enable this alignment. This alignment in connection with the height adjustment minimizes the distance between the charging coil 308 and the charging coil in the EV 500 to maximum the energy transfer efficiency.

In order to transmit energy from the charging coil 308 to the charging coil of the EV 500 there are commonly two methods employed inductive coupling and resonant coupling both of which are shown in FIG. 3C. Inductive coupling or inductive charging is much more efficient compared to resonant charging. Inductive coupling requires the charging coil 308 and the charging coil of the EV 500 to be tightly coupled to each other and inductive charging efficiency is related to the distance and alignment from charging coil 308 (the transmit coil) to the charging coil of the EV 500 (the receiving coil). As described above a telescoping arrangement can move charging coil 308 vertically and horizontally to achieve this alignment with the charging coil of the EV 500.

Described below is a closed loop current method for precise placement of the charging coil 308 in proximity of the charging coil of the EV 500 to achieve high efficiency inductive charging. After initial placement of the charging pad 300 under the EV 500 in proximity of its charging coil, the charging coil 308 sending a charging signal to the EV 500 to start charging. A high frequency voltage will be established on the charging coil of the EV 500. An onboard charger in the EV 500 will start rectifying the high frequency current to direct current and charge the battery inside the vehicle.

The parameters of the initial charging current are commonly determined by the on-board charger in the EV 500 based on the status of the batteries in the EV 500. After charging has been initiated, the rate of change of the charging current rapidly begins to slow. In a relatively short time, the charging rate becomes constant.

The CPU 314 in the charging pad 300 measure charging current at charging coil 308 input. Based on transformer theory, Vin/Vout=n1/n2=N, where n1 and n2 is the turn ratio. This ratio is constant. Thus:

Vin*Iin=Vout*Iout*η (Equation 1)

Where:
Vin is input voltage on the charging coil
Iin is input current on the charging coil
Vout is output voltage on the receiving coil
Iout is the current on the receiving coil
η is energy transmit efficiency of the charging and receiving coil

Equation 1, can be re-written as:

Vin*Iin=Vin/N*Iout*η (Equation 2)

Which can again be rewritten as:

Iin=N*Iout*η (Equation 3)

As described above, at a short time Iout is constant. Because the input current Iin is directly related to energy transfer efficiency q, and further because the transformer efficiency η is strictly related to air gap and alignment of the primary and secondary coil, the CPU 314 can assess the airgap and the alignment of the charging coil 308 and the charging coil in the EV 500 based on the comparison of the detected efficiency. With this information, the charging pad can adjust the height and alignment of the charging coil 308. A rising structure, described above, can adjust the height of the charging coil 308 to minimize the airgap from z direction, and the either servo motors or other mechanisms can be employed to adjust the x-y position of the charging coil. By making continued adjustment, the CPU 314 can be determined a position of maximum efficiency of the energy transfer by searching for minimum Iin. In some instances, the Iout parameter is determined by the on-board charger of the EV 500 and communicated to the CPU 314 of the charging pad 300.

Either additionally or alternatively, the alignment of the charging coil 308 and the charging coil of the EV 500 can be assessed using one or more temperature sensors. The temperature sensors may be placed on or proximate the surface of the charging coil 308 to detect temperature differences. When the charging coil 308 and the charging coil of the EV 500 are not aligned, the effective area that flux passes through both coils are the ones effectively transmit the energy from charging coil 308 to charging coil of the EV 500 (i.e., the receiving coil). The losses of this transfer will be as the form of heat generated on the common area of the charging coils. A temperature sensor in the areas of alignment will measure higher temperature than the ones on the mis-aligned area. A closed loop control algorithm may be employed by the CPU 314 to optimize the maximum number of temperature sensors in the hot area to seek to minimize losses during the energy transfer.

The charging pad 300 is relatively thin and designed to fit under a vehicle as depicted in FIG. 1. The exterior of the charging pad 300 may be formed of metals or plastics, such as high-density polyethylene, and other materials that can withstand the pressure of a vehicle driving over the charging pad 300. Though not intended to be driven on, given the abilities of the average motorist, such a scenario is highly likely. In this, as well as other aspects the charging pad 300 meets the requirements set forth by for example Society of Automotive Engineers (SAE) or other relevant government bodies promulgating standards and requirements for automotive related equipment.

As with the charging station 200, the charge pad 300 includes one or more CPU's 314 including, a processor, a memory, one or more sets of instructions including software, firmware, applications, and a communications module for communication between the charging pad 300 and a communications module in the EV 500 or between the charging pad 300 and the autonomous robot 400. Before initiating charging the communications module in the CPU 314 begins communication with the EV 500. This communication may utilize a predefined protocol. In some instances, this protocol may be defined by the service provider of the AWECS, or a standard for EV charging.

As will be described in greater detail below, the status of charging of the EV 500 can be monitored and data regarding SOC of the batteries of the EV 500 can be collected by the charging pad 300. This data can be communicated to the charging station 200, where the communications module sends the data to a server which is in communication with the operator of the EV 500 via, for example, an application running on a smart phone or other connected device.

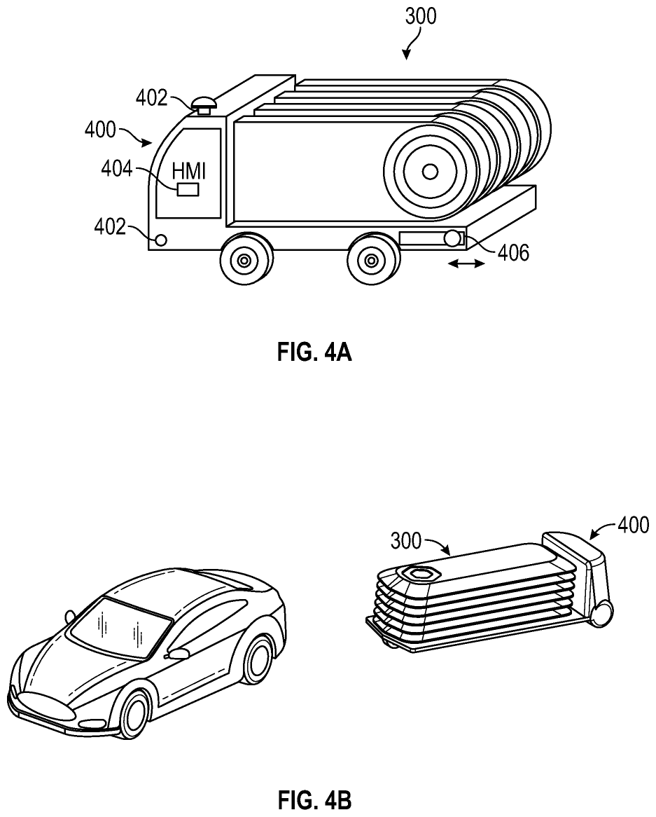

FIGS. 4A and 4B depict an autonomous robot 400 carrying a plurality of charging pads 300. The autonomous robot 400 is a wheeled vehicle configured to navigate in a parking facility without need of direct human intervention. The autonomous robot 400 may include a variety or sensors 402 including light detection and ranging (LIDAR) sensors, ultrasonic sensors, and cameras enabling the autonomous robot 400 to detected objects such as a vehicles, pedestrians and others which may be traversing the parking facility. Further, these sensors 402 enable the autonomous robot 400 to align itself with an EV 500 such that a charging pad 300 can be removed from the autonomous robot 400 and properly placed under an EV as shown in FIG. 1. As with the charging pad 300 and the charging station 200, the autonomous robot 400 includes one or more CPU's 404 including, a processor, a memory, one or more sets of instructions including software, firmware, applications, and a communications module enabling wireless communication with the charging pad 300, charging station 200, or directly with one or more servers as described in greater detail below.

One or more robotic arms 406 is operably connected to the autonomous robot 400. The robotic arms 406 are configured to select one of the charging pads 300 from those on the autonomous robot 400 and place the charging pad 300 under the EV 500, as depicted in FIG. 1. Using a combination of the sensors 402 on the autonomous robot 400 and the techniques described above, the charging pad 300 is positioned under the EV 500 such that the charging coil 308 is aligned with the charging coil of the EV 500.

Upon completion of charging of the EV 500, the charging pad 300 may transmit a signal to the autonomous robot 400 or the charging station 200 indicating that charge is complete and the charging pad 300 may be collected. Similarly, if charging is interrupted such as the operator driving off in the EV 500 such a signal can be transmitted. This charge complete or charge interrupted or in some instances a charge failure signal initiates a response from the autonomous vehicle 400 causing it to return to the location of the charging pad 300 with which it is communicating. The autonomous vehicle 400 again extends its robotic arm(s) 406 to retrieve the charging pad 300. If sufficient charge remains in the charging pad 300, the charging pad 300 may remain on the autonomous robot 400 for use with the next EV 500. Alternatively, if the state of charge of the battery 304 in the charging pad 300 is sufficiently depleted the autonomous robot 400 returns the charging pad 300 to the charging station 200 where it is placed on one of the racks 201 and connected to the contacts 204 and re-charge is initiated. Again, it is the robotic arms 406 which manipulate the charging pad 300 to place it on the appropriate rack 201.

The sensors 402 along with GPS signals, inertial measurement units (IMUs) and other position detection devices enable the autonomous robot to detect the local environment and make decisions for autonomously driving around the parking structure. A continuously updated three-dimensional (3D) local map of the parking structure may be stored in the memory and accessed by the processor of the CPU 404. This map may be synchronized with other maps stored on the server such that updates may also be pushed from the server to the autonomous robot 400. This combination assists the autonomous robot in navigating the parking structure and minimize undesirable interaction with vehicles including EVs 500 or pedestrians.

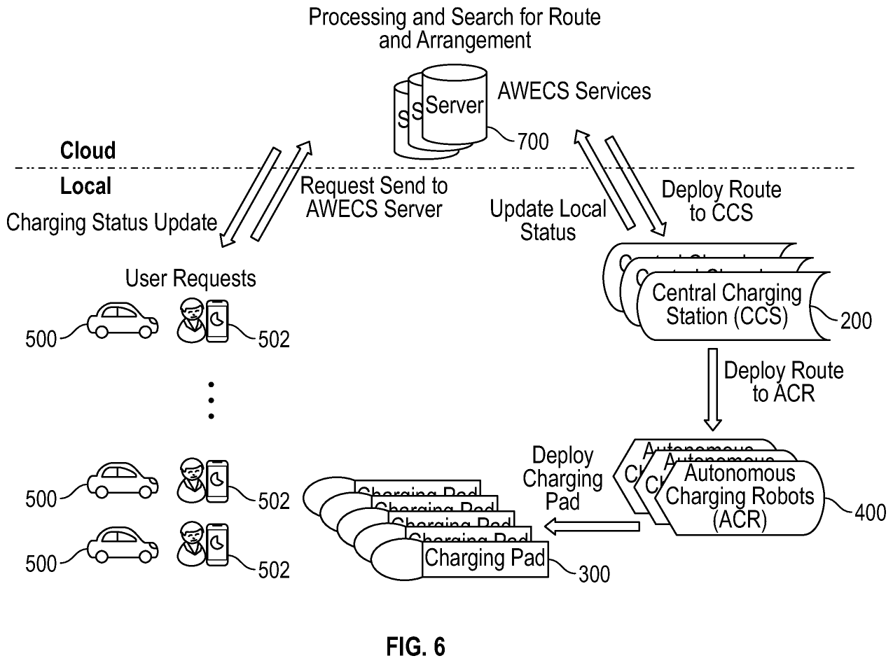

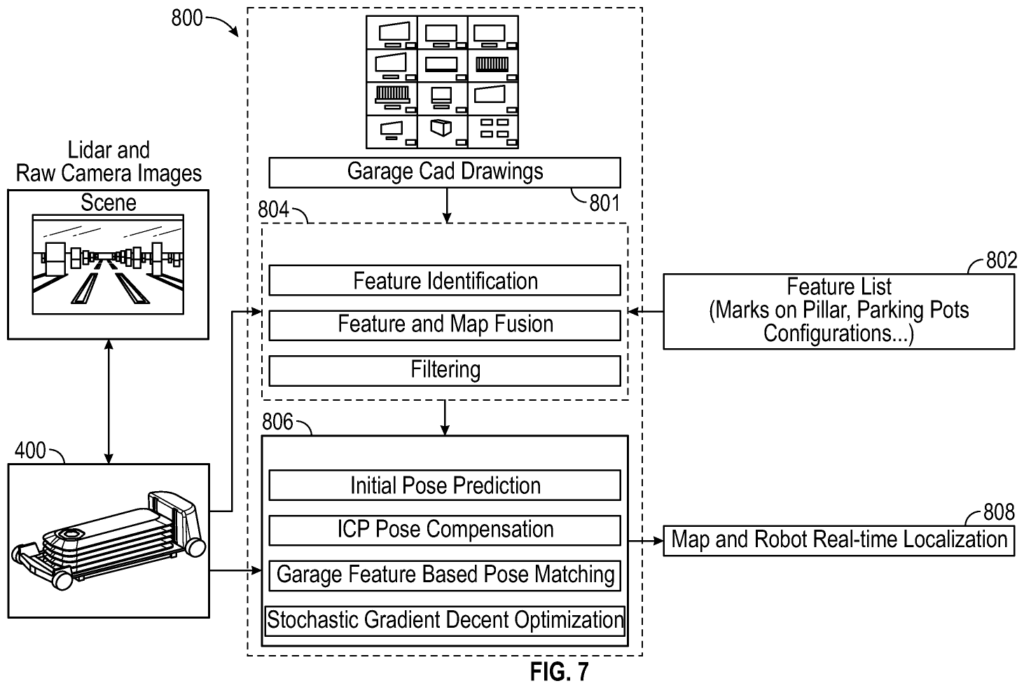

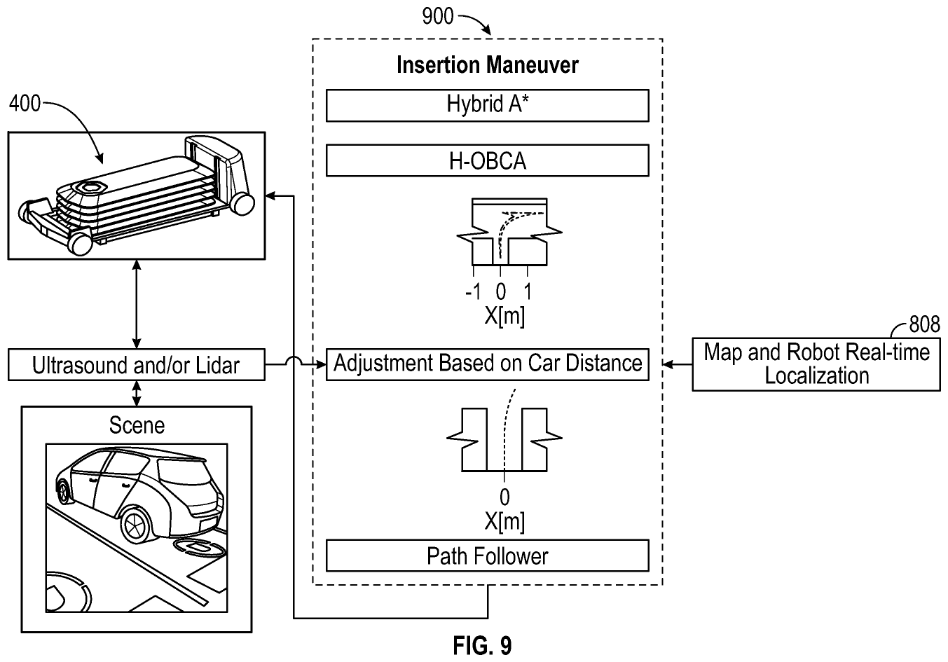

Upon receiving a set of instructions to charge a particular EV, as described in greater detail below, the autonomous robot 400 will determine if sufficient charging pads 300 are on board to accommodate the instructions. If there are the autonomous robot 400 responds to the instructions and executes the placement at the appropriate time according to the instructions. If not, then the autonomous robot 400 proceeds to the charging station 200 to place charging pads 300 with insufficient charge on the charging station 200 and to extract charged charging pads 300 to carry out the instructions. The autonomous robot 400 and charging station 200 may undertake communications to determine which charging pads 300 to extract, or a server system 700 (FIG. 6) may include an identification of the specific charging pad 300 to place for a particular EV 500 based on charge state of the charging pads 300, which the charging pads 300 or the charging station 200 report to the server via a communications module in the CPU 208, 314, respectively. The instructions may also consider which charging pads 300 are equipped with the appropriate charging algorithm for a particular battery on the EV 500 and base the identification of which charging pad 300 to utilize based on this factor as well.

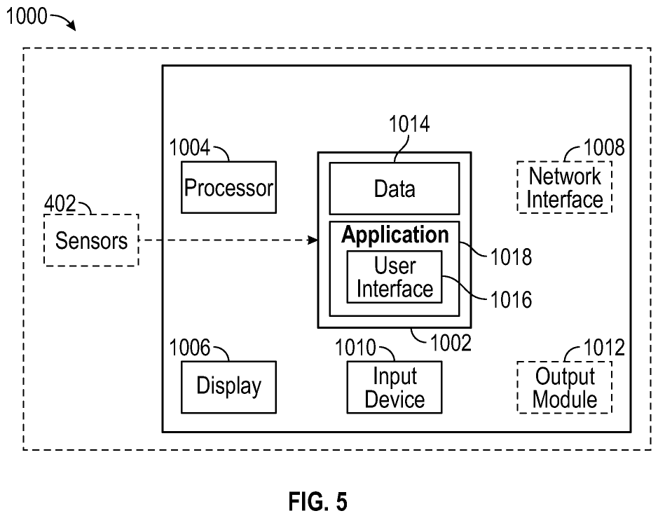

The charging station 200, charging pad 300, and autonomous robot 400 are all described as including a CPU. Specifically, CPUs 208, 314, and 404. Each of these CPU's may include some or all of the hardware described in connection with CPU 1000 in FIG. 5. Those of ordinary skill in the art will recognize that the methods and systems described herein may be embodied on one or more applications operable on a CPU 1000 (FIG. 5). As an initial matter, these systems and methods may be embodied on one or more firmware, software or applications. These applications enable battery monitoring, battery charging, communications, navigation, mapping, object detection and avoidance, and others without departing from the scope of the disclosure. Of course, those of skill in the art will recognize that a variety of additional and complementary uses of the image processing methods described herein.

Reference is now made to FIG. 5, which is a schematic diagram of a CPU 1000 configured for use with the methods of the disclosure. CPU 1000 may be coupled with sensors 402 directly or indirectly, e.g., by wireless communication. CPU 1000 may include a memory 1002, a processor 1004, a display 1006 and an input device 1010. Processor or hardware processor 1004 may include one or more hardware processors. CPU 1000 may optionally include an output module 1012 and a network interface 1008. Memory 1002 may store an application 1018 and image data 1014. Application 1018 may include instructions executable by processor 1004 for executing the methods of the disclosure.

Application 1018 may further include a user interface 1016. data 1014 may include sensor data, map data and others useable herein. Processor 1004 may be coupled with memory 1002, display 1006, input device 1010, output module 1012, network interface 1008 and sensors 402.

Memory 1002 may include any non-transitory computer-readable storage media for storing data and/or software including instructions that are executable by processor 1004 and which control the operation of CPU 1000 and, in some embodiments, may also control the operation of imaging device 1015. In an embodiment, memory 1002 may include one or more storage devices such as solid-state storage devices, e.g., flash memory chips. Alternatively, or in addition to the one or more solid-state storage devices, memory 1002 may include one or more mass storage devices connected to the processor 1004 through a mass storage controller (not shown) and a communications bus (not shown).

Although the description of computer-readable media contained herein refers to solid-state storage, it should be appreciated by those skilled in the art that computer-readable storage media can be any available media that can be accessed by the processor 1004. That is, computer readable storage media may include non-transitory, volatile and non-volatile, removable and non-removable media implemented in any method or technology for storage of information such as computer-readable instructions, data structures, program modules or other data. For example, computer-readable storage media may include RAM, ROM, EPROM, EEPROM, flash memory or other solid-state memory technology, CD-ROM, DVD, Blu-Ray or other optical storage, magnetic cassettes, magnetic tape, magnetic disk storage or other magnetic storage devices, or any other medium which may be used to store the desired information, and which may be accessed by workstation 1001.

Application 1018 may, when executed by processor 1004, cause display 1006 to present user interface 1016. User interface 1016 may be configured to present to the user a variety of images and models as described herein. User interface 1016 may be further configured to display and mark aspects of the images and 3D models in different colors depending on their purpose, function, importance, etc.

Network interface 1008 may be configured to connect to a network such as a local area network (LAN) consisting of a wired network and/or a wireless network, a wide area network (WAN), a wireless mobile network, a Bluetooth network, and/or the Internet. Network interface 1008 may be used to connect between CPU 1000 and servers (FIG. 6). Network interface 1008 may be also used to receive data 1014 from the servers. Input device 1010 may be any device by which a user may interact with a CPU 1000, such as, for example, a mouse, keyboard, foot pedal, touch screen, and/or voice interface. Output module 1012 may include any connectivity port or bus, such as, for example, parallel ports, serial ports, universal serial busses (USB), or any other similar connectivity port known to those skilled in the art.

FIG. 6 depicts a schematic of the architecture of the system 100, including a plurality of EVs 500. Each operator of an EV 500 is provided access to an application running on their personal connected device 502 such as a smart phone or the like. The application enables connectivity between the operator and a charging system server 700 using the mobile connectivity or a wireless connectivity. Upon reaching a parking structure and determining that the operator would like to charge their EV 500. the operator opens the application. The application may require verification of payment information, location of vehicle, type of vehicle and other relevant information. The request may make a timed charging request or a stat of charge timing request. Some of this may be addressed previously such as when the operator becomes a subscriber of the charging services via the application. The AWECS servers 700 which may be cloud based servers receive the request from the operator via the application running on the mobile device 502. Upon verifying the details of the request and the availability of a charging pad 300 compatible with the EV 500 and having sufficient charge to perform the desired charging, the server 700 transmits a signal to the charging station 200 which communicates them to the autonomous robot 400, alternatively this signal from the server could be sent directly to the autonomous robot 400. In either event the details of the request are received by the autonomous robot 400. If there is no charging pad 300 available to meet the request, the server 700 may transmit possible alternative arrangements such as reduced charging, or delayed starting of charging, or simply reject the request as currently unavailable depending on the planned availability of charging pads 300.

The details received by the autonomous robot 400 may include a route that has been planned by an application running in the server, which takes account of the position of the autonomous robot 400, other requests for charging already received, the distance from current location of the charging robot 400 and the EV 500 for which a request has been made, and other data such as an urgent request or a premium paid for expedited service or other factors. With this information and following the map or the planned route to the EV 500 for which the request was made the autonomous robot 400 proceeds to the EV 500. Once on location the robotic arms 400 of the autonomous robot 400 remove a charging pad 300 and place it under the EV 500. A combination of the sensors 402 and other features in the charging pad 300 along with communications between the charging pad 300 and the EV 500 ensure proper alignment and height adjustment of the charging coil 308 and a corresponding charging coil on the EV 500. Once alignment is confirmed charging of the EV 500 batteries can commence. All charging statuses, system statuses and other relevant data from the EV 500, charging pad 300, autonomous robot 400, and charging station 200 are reporting back to AWECS servers for tracking and monitoring, as well as being pushed to the operator to verify their EV 500 is being charged.

One of the issues that needs to be resolved prior to commencement of charging is determination of the charging algorithm that is required to charge the specific batteries installed in the specific EV 500. This data can be retrieved from the EV 500 by the CPU 314 in the charging pad 300 using its communications module as described above.

As will be appreciated, one of the functions of the server 700, which is a cloud-based system is to collect the data from the sensors 402 of the autonomous robot 400. This sensor data can be used to update the 3D map for parking facility. Originally, the parking facility would have been scanned to create the original 3D map during installation of the system 100. To generate the original map imaging, laser scans, and GPS systems may have been deployed to identify necessary information including the number of parking spots, orientation of the parting spots, route inside parking structure, actual dimension for each parking spot, and all details about the local infrastructure. However, some of this information becomes dated as soon as the parking facility is opened to the public. Poor parking by users, maintenance, and other factors may need to be considered and used to regularly update the 3D map to provide up to date information for the servers 700 and the autonomous robot 400. This data is best received from the autonomous robot 400 as it goes through its routine of deploying charging pads 300.

While 3D maps are referred to herein to identify the environment in which the autonomous robot 400 operates the creation of a precise map will now be described. In autonomous robots, a precise map is essential as it allows self-driving vehicles to be operated in complex environments using only local sensors. Simultaneous Localization and Mapping (SLAM), is one of the most important algorithms of autonomous robots. SLAM is the process by which a vehicle constructs a map of its surrounding environment, and it localizes itself relative to the map simultaneously. The commonly used SLAM algorithms can be divided into two categories: filter-based algorithms and optimization-based algorithms. Although their applications are different, both approaches depend greatly on features (or landmarks) of surrounding environment, such as buildings, traffic signs, and street infrastructures. Some of widely used filter-based methods have been derived using the Extended Kalman Filter (EKF). However, EKF based SLAM algorithms have a heavy computational burden to be implemented. In order to alleviate this issue, the extended information filter (EIF) approach has been developed. The EIF approach uses an information matrix, which is an inverse form of the covariance matrix from the Kalman filter. To further decrease the computational time of the EIF sparse information filter forms have been developed. Although the information filter can integrate newly detected landmarks rapidly, the state estimation process requires the inverse of the entire information matrix, which can still be computationally heavy FastSLAM methods have been introduced when landmark covariance data is not readily available. Graph-based SLAM, one of optimization-based methods, is an intuitive way to solve the SLAM problems. This approach constructs the SLAM problem as a graph consisting of nodes and edges. In general, nodes represent poses of vehicles and landmarks, and edges represent spatial constraints between nodes. Graph-based SLAM solves an error minimization problem to reduce mismatch between real-time observations and spatial constraints (edges) A further approach is the use of a nonlinear least square method for the optimization formulation, but due to its nonlinearity, this method is challenging to be implemented. Another approach decreases the number of edges for the sake of improving convergence speed at the cost of accuracy of the map. Additional of nonlinear optimization-based approaches include Gauss-Seidel relaxation, which uses linearization of the SLAM problems. Still further a Multi-level Relaxation algorithm has been proposed to improve convergence speed for sparse approximation problems. Alternatively, a Stochastic Gradient Descent (SGD) has been proposed to solve the SLAM problems by providing rapid updates on the state vector, allowing the algorithm to escape local minima. Still further, visual SLAM approaches which are a branch of the SLAM system uses a camera to build a map.

Visual SLAM approaches are of major interest at the present time because the optical or visual sensors are the cheapest and easy to set up. The visual SLAM has two main approaches to solve a SLAM problem: filter-based and keyframe-based. The filter-based SLAM gathers information at each frame with a probabilistic theory. A pose of a vehicle is estimated by using the information of each frame. The keyframe-based SLAM choses certain past frames to compute a current pose of a vehicle, instead of considering all the features of a frame. One of the most popular visual SLAM methods, ORB-SLAM, is the keyframe-based SLAM. In all of the aforementioned works, the methods use posed based landmarks.

While a myriad of approaches have been proposed, none of these methods standing alone provides the features of the proposed mapping. In part, all of the foregoing methodologies and algorithms rely on one or more of (1) ascertainment of the features of the surrounding environment (2) high precision GPS and (3) repeated path with loop closure. Ascertainment of the surrounding environment is often very time consuming, often requiring hundreds of hours of manual work to properly label. Further, in a parking garage, the environment is constantly changing as cars enter and leave the garage. Additionally, in indoor parking structures, high precision GPS is often not available or only inconsistently available due to the nature of the structure. Finally, repeated path with loop closure is not be readily available since the pathways of the autonomous robot are not regularly repeated.

To address these issues, the instant disclosure employs an application 800 which performs a multi-step process for generating a high precision SLAM of an indoor parking facility. As an initial matter, a set of drawings 801 such as those available from the architect, the owner, or the operator of the parking garage and a features list 802 is input into a fusion algorithm 804. The features list 802 may include, but is not limited to the identification of pillars, marking on pillars, parking spot lane marking, parking spot number marking, and others. The fusion algorithm 804 receives live camera images and lidar images from sensors 402 of the autonomous robot 400. The fusion algorithm 804 will then process, for example, using an iterative closest point method to compensate for poor positioning and pose of the autonomous robot and fuse real-time and prerecorded lidar and raw camera images to match them in combination with the drawings 801 to generate an actual marking of for example a parking spot or other feature parking garage in the form of spatial constraints. The fusion algorithm 804 may employ a standard feature-based-matching method is used on a set of tailored features identified for parking structures.

Both the live camera images and lidar from the sensors 402 are also fed to a SLAM algorithm 806. The SLAM algorithm 806 also receives the output of the fusion algorithm 804, particularly the spatial constraints. These data are processed to perform an initial pose prediction. The SLAM algorithm 806 compensates for the initial pose estimation compensate poor vehicle pose to determine a set of a tracks computed from visual and lidar information. Next, the spatial constraints are employed to construct a map by using a stochastic gradient descent optimization without any pose-based landmark. The SLAM algorithm 806 then outputs both a real time map and a real time location of the autonomous robot 400.

In one embodiment, the application 800 runs locally in the CPU 404 of the autonomous robot 400. Further, this location and updated map can be transmitted to the AWECS server 700 (FIG. 6), to both track the real-time location of the autonomous robot 400 and to update the map, which allows the AWECS server 700 to provide further guidance to the autonomous robot 400 in accordance with the disclosure. Additionally, or alternatively, the application 800 may run on the AWECS server 700 and communicate the updated map and location of the autonomous robot 400. Further, the application 800 may run on the CPU 208 of the charging station 200 and communicate with both the AWECS server 700 and the autonomous robot 400.

As noted herein, one of the aspects of the disclosure is directed to the placement of a charging pad 300 under a vehicle by the autonomous robot 400 such that the charging coil 308 is in proximity of the charging coil of the EV 500. The problem of generating trajectories for autonomous robots 400 in a cluttered parking environment is a difficult task, especially in tight environments. The main challenge arises from the non-linear and non-holonomic vehicle dynamics and the non-convexity of the free space. Indeed, it has been shown that the task of finding a collision-free path is, in general, NP-hard (non-deterministic polynomial-time hardness). Therefore, an ideal all-purpose trajectory generation algorithm does not exist. Recently, optimization-based path planning algorithms, such as model predictive control (MPC), have attracted attention, with application ranging from (unmanned) aircraft to robots to autonomous cars. This can be attributed to the increase in computational resources, the availability of robust numerical algorithms for solving optimization problems, as well as MPC's ability to systematically encode system dynamics and safety constraints inside its formulation. The main challenge in optimization-based approaches is that the obstacle avoidance constraints induce a non-convex optimization problem, often in the form of integer variables, rendering the resulting optimization problem computationally difficult to solve. By introducing auxiliary decision variables, obstacle avoidance constraints can be reformulated as a set of smooth constraints, allowing the use of mature gradient and Hessian-based numerical solvers. Unfortunately, it has been observed that, due to the non-holonomic dynamics and the non-convexity of the obstacle-free space, the solution quality of these optimization problems in parking problems critically depend on the initial guess provided to the numerical solver. In accordance with the disclosure, the instant application seeks to address these issues in the context of placement or removal of the charging station 300 under an EV 500 using the autonomous robot 400.

The autonomous robot 400 requires a precise insertion path underneath the target vehicle which does not touch the target and surrounding vehicles. Moreover, the path must be generated in real time. To achieve the desired result, application 900 employs a combination of algorithms. The first algorithm employed is the Hybrid A* path planner. The Hybrid A* path planner is used in combination the hierarchical optimization-based collision avoidance algorithm. Specifically, the application 900 utilizes the Hybrid A* and a simplified vehicle model to quickly generate a coarse path that approximately satisfies the vehicle dynamics. This coarse path is subsequently passed used to initialize the H-OBCA algorithm, which uses a full vehicle model to generate a high-quality collision-free insertion path. The collision free path enables the CPU 404 of the autonomous robot 400 to begin insertion of the charging pad 300 under the EV 500. The collision-free insertion path is adjusted in real-time as the charging pad 300 is inserted based on data collected by the sensors 402 (e.g., ultrasound, Lidar, images, laser scanner, etc.) of the autonomous robot 400. The sensed distance from the tires of the EV 500, by sensors 402, is used to adjust the collision-free insertion path in real-time. Further, the generated and updated insertion path can be tracked by a path following controller in the application 900. Upon completion of the placement, the collision-free path may also be employed by the autonomous robot 400 to enable it to proceed away from the EV 500 and when appropriate to return to the EV 500 to remove the charging pad 300 at the completion of charging. While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects.

1. A wireless autonomous electric vehicle (EV) charging system comprising:
a charging station configured to receive electrical energy from an external source;
a plurality of charging pads, each charging pad including a rechargeable battery and configured to be charged by the charging station, and to be placed under an EV for wireless charging of a battery of the EV, and
an autonomous robot, the autonomous robot configured to retrieve one or more charging pads from the charging station and deliver the charging pad to an EV, wherein upon placement of the charging pad under the EV the charging pad wirelessly charges the battery of the EV.

2. The wireless autonomous EV charging system of claim 1, further comprising a server, the server configured to receive a request for charging and to transmit instructions to charging station, charging pads, or autonomous robot in response to the request for charging.

3. The wireless autonomous EV charging system of claim 2, wherein the instructions identify one or more of a type of EV, a charging algorithm, a location of the EV, a duration of charge, a desired charge level, or a route to the EV.

4. The wireless autonomous EV charging system of claim 1, wherein each of the plurality of charging pads include a height adjustment mechanism configured to bring a charging coil of the charging pad in proximity to a charging pad of the EV.

5. The wireless autonomous EV charging system of claim 1, wherein each of the plurality of charging pads includes a wireless charger configured to convert direct current (DC) electrical energy in the rechargeable battery to an alternating current (AC) to enable wireless transmission of electrical energy to the EV.

6. The wireless autonomous EV charging system of claim 1, wherein the charging station includes one or more battery chargers configured to receive electrical energy from the external source and convert the electrical energy to a form suitable for storage in the rechargeable battery of the charging pad.

7. The wireless autonomous EV charging system of claim 1, wherein the charging station is configured to support and charge a plurality of charging pads.

8. The wireless autonomous EV charging system of claim 1, wherein one or more of charging station, charging pads, and autonomous robot include a central processing unit including a communications module, and configured to receive and transmit communications with the charging station, charging pads, autonomous robot, a server, or an EV.

9. The wireless autonomous EV charging system of claim 1, wherein the autonomous robot includes at least one robotic arm configured to engage a charging pad and remove it from a charging station and place it on the autonomous robot.

10. The wireless autonomous EV charging system of claim 9, wherein the at least one robotic arm is configured to engage a charging pad on the autonomous robot and place the charging pad under an EV.

11. The wireless autonomous EV charging system of claim 10, wherein the at least one robotic arm is configured to engage a charging pad located on the ground and place the charging pad on the autonomous robot.

12. The wireless autonomous EV charging system of claim 1, wherein the autonomous robot further comprises at least one sensor.

13. The wireless autonomous EV charging system of claim 12, wherein the at least one sensor is selected from the group consisting of ultrasonic sensors, cameras, light detection and ranging (LIDAR) sensors, and inertial monitoring units (IMU).

14. The wireless autonomous EV charging system of claim 1, further comprising a server in communication with an application running on a mobile device, the application configured to enable a user to request charging services for an EV.

15. The wireless autonomous EV charging system of claim 14, wherein the application requires input of one or more of a type of EV, a location of the EV, a charging algorithm, a location of the EV, a duration of charge, a desired charge level, a payment method, a level of urgency, or a priority request.

16. The wireless autonomous EV charging system of claim 15, wherein the server communicates with one or more of the charging stations, charging pads, and autonomous robot to receive charging status of the EV.

17. The wireless autonomous EV charging system of claim 16, wherein the server communicates a received charging status of the EV to the application running on the mobile device.

18. The wireless autonomous EV charging system of claim 1, wherein upon termination of charging, the autonomous robot retrieves the charging pad.

19. The wireless autonomous EV charging system of claim 18, wherein upon retrieval of the charging pad, if the charging pad is in need of charging the autonomous robot returns the charging pad to the charging station.

20. The wireless autonomous EV charging system of claim 18, wherein upon retrieval of the charging pad, if the charging pad has sufficient charge to charge another EV, the charging pad is retained on the autonomous robot for further use.

21.-23. (canceled)
